(19) United States
(12) Patent Application Publication
(10) Pub. No.: US 2004/0074785 A1
(43) Pub. Date: Apr. 22, 2004

(54) Analyte sensors and methods for making them

(76) Inventors: James D. Holker, Alta Loma, CA (US); John J. Mastrototaro, Los Angeles, CA (US); Glenn Noronha, Oceanside, CA (US); Rajiv Shah, Palos Verdes, CA (US); Yanan Zhang, Valencia, CA (US); Udo Hoss, Sherman Oaks, CA (US); Kevin D. Branch, Northridge, CA (US)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 10/273,767

(22) Filed: Oct. 18, 2002

(51) Int. Cl. G01N 27/26

(52) U.S. Cl. 205/777.5; 204/403.01

(57) ABSTRACT

Embodiments of the invention provide analyte sensors having stabilized coating compositions and methods for making such sensors. Illustrative embodiments include electrochemical glucose sensors having stabilized glucose oxidase coatings that are generated for example, via spin coating processes.

### CROSS REFERENCE TO RELATED APPLICATIONS

This application is related to U.S. Pat. No. 6,413,393 “SENSOR INCLUDING UV-ABSORBING POLYMER AND METHOD OF MANUFACTURE”; U.S. Pat. No. 6,368,274 “REUSABLE ANALYTE SENSOR SITE AND METHOD OF USING THE SAME”; U.S. Pat. No. 5,786,439 “HYDROPHILIC, SWELLABLE COATINGS FOR IMPLANTABLE DEVICES”; U.S. Pat. No. 5,777,060 “SILICON CONTAINING BIOCOMPATIBLE MEMBRANES”; U.S. Pat. No. 5,391,250 “METHOD OF FABRICATING THIN FILM SENSORS”; PCT International Publication Number WO 01/58348 “IMPROVED ANALYTE SENSOR AND METHOD OF MAKING THE SAME”, and U.S. Pat. No. 5,390,671 “TRANSCUTANEOUS SENSOR INFUSION SET”, the contents of each of which are incorporated herein by reference.

### BACKGROUND OF THE INVENTION

1. Field of the Invention

The present invention relates to sensors for the detection and measurement of analytes such as glucose and methods for making them.

2. Description of Related Art

Analyte sensors such as electrochemical sensors are manufactured according to a variety of processes for use in a wide number of specialized sensor applications. For example, electrochemical sensors are typically manufactured using thin film processes known in the art. Such thin film sensors generally comprise one or more thin conductors applied by thin film deposition processes and subsequently patterned by photolithographic mask and/or etch techniques in combination with layers of nonconductive film materials, such as polyimide film. The conductors are typically shaped to define distal end sensor tips having an appropriate electrode material thereon, in combination with proximal end contact pads adapted for conductive connection with appropriate electronic monitoring equipment. Additional layers of coatings having various functional properties are typically included in such sensors. In recent years, thin film sensors of this general type have been designed for use as transcutaneous sensors in medical applications. As one example, thin film sensors have been designed for use in monitoring blood glucose levels in a diabetic patient.

A wide variety of methods for producing sensors, such as those used in sensor sets designed for the determination of a body characteristic such as blood glucose levels, are known in the art. Examples of such sensors, sensor sets and methods for their production are described, for example, in commonly assigned U.S. Pat. Nos. 5,390,691, 5,391,250, 5,482,473, 5,299,571, 5,568,806 as well as PCT International Publication Number WO 01/58348, the contents of each of which are incorporated herein by reference.

While a number of sensor designs and processes for making such sensors are known in the art, there continues to be a need for sensors having improved characteristics such as enhanced longevity, linearity and regularity, as well as optimized signal to noise ratios. There is also a need for the identification of the methods and processes that allow for the generation of sensors having these optimized qualities. The present invention fulfills these needs and provides further related advantages.

### SUMMARY OF THE INVENTION

Embodiments of the invention disclosed herein provide methods for producing sensors of the type used, for example, in subcutaneous or transcutaneous monitoring of blood glucose levels in a diabetic patient. More specifically, the disclosure provided herein teaches methods for applying very thin enzyme coatings to these types of sensors as well as sensors produced by such processes. Preferable methods for producing the sensors of the invention include coating processes. Surprisingly, sensors having enzyme coatings formed by such processes have a number of superior qualities including enhanced longevity, linearity and regularity, as well as improved signal to noise ratios. In addition, certain sensor embodiments of the invention that utilize glucose oxidase coatings formed by such processes are designed to recycle hydrogen peroxide and improve the biocompatibility profiles of such sensors.

An illustrative embodiment of the invention is a sensor designed for implantation within a body that consists of a base layer, a sensor layer disposed upon the base layer which includes a plurality of sensor elements, an enzyme layer (preferably less than 2 microns in thickness) disposed upon the sensor layer which coats sensing elements on the sensor layer, and a cover layer. Typically the enzyme layer comprises glucose oxidase, preferably in a substantially fixed ratio with a carrier protein. Typically the carrier protein comprises albumin, preferably in an amount of about 5% by weight. In preferred embodiments of the invention, the cover layer is an analyte contacting layer which is disposed on the sensor so as to regulate the amount of analyte that can contact the enzyme layer. Preferably the analyte contacting layer is a glucose limiting layer that limits the amount of glucose analyte that can contact the glucose oxidase coating on the sensor. In highly preferred embodiments, the sensor includes an adhesion promoter layer disposed between the enzyme layer and the glucose limiting layer.

Another embodiment of the invention is an electrochemical glucose sensor having hydrogen peroxide recycling capabilities. Typically, such sensors include a base layer, a sensor layer disposed upon the base layer, wherein the sensor layer includes at least one working electrode and at least one counter electrode, a glucose oxidase layer disposed upon the sensor layer that coats at least a portion of the working electrode and at least a portion of the counter electrode in a manner such that the working electrode oxidizes hydrogen peroxide that is produced by glucose oxidase upon reaction with glucose, and a glucose limiting layer disposed on the sensor so as to regulate the amount of glucose that can contact the glucose oxidase layer and to inhibit the diffusion of hydrogen peroxide into the environment in which the sensor is placed. Optionally such sensor embodiments further include a reference electrode on the sensor layer, wherein the glucose oxidase layer is disposed upon the sensor layer so as to coat at least a portion of the reference electrode.

The disclosure herein provides methods for making the sensor embodiments of the invention. A preferred embodiment of the invention is a method of making a sensor by providing a base layer, forming a sensor layer on the base layer, spin coating an enzyme layer on the sensor layer and then forming an analyte contacting layer on the sensor, wherein the analyte contacting layer regulates the amount of analyte that can contact the enzyme layer. While the preferred process for applying very thin enzyme coatings is a spin coating processes, such very thin coatings can also be applied by dip and dry processes, low-shear spraying processes, ink-jet printing processes, silk screen processes and the like. In preferred methods, the enzyme layer is vapor crosslinked on the sensor layer. In a typical embodiment of the invention, the sensor layer is formed to include at least one working electrode and at least one counter electrode. In highly preferred embodiments, the enzyme layer is formed on at least a portion of the working electrode and at least a portion of the counter electrode. Typically, the enzyme layer that is formed on the sensor layer is less than 2, 1, 0.5, 0.25 or 0.1 microns in thickness. Preferably the enzyme layer comprises glucose oxidase, glucose dehydrogenase, lactose oxidase, hexokinase or lactose dehydrogenase. In a specific method, the enzyme layer comprises glucose oxidase that is stabilized by coating it on the sensor layer in combination with a carrier protein in a fixed ratio. Typically the carrier protein is albumin. Preferably such methods include the step of forming an adhesion promoting layer disposed between the glucose oxidase layer and the analyte contacting layer. Optionally, the adhesion promoting layer is subjected to a curing process prior to the formation of the analyte contacting layer.

The invention also provides additional articles of manufacture including sensor sets and kits. In one such embodiment of the invention, a kit and/or sensor set, useful for the sensing an analyte as is described above, is provided. The kit and/or sensor set typically comprises a container, a label and a sensor having an extremely thin enzyme coating as described above.

Other objects, features and advantages of the present invention will become apparent to those skilled in the art from the following detailed description. It is to be understood, however, that the detailed description and specific examples, while indicating preferred embodiments of the present invention are given by way of illustration and not limitation. Many changes and modifications within the scope of the present invention may be made without departing from the spirit thereof, and the invention includes all such modifications.

### BRIEF DESCRIPTION OF THE FIGURES

FIG. 1 provides a diagrammatic view of a glucose sensor of the current invention. FIG. 2 provides a schematic of the well known reaction between glucose and oxygen in the presence of glucose oxidase. As shown in a stepwise manner, this reaction involves glucose oxidase (GOX), glucose and oxygen in water. In the reductive half of the reaction, two protons and electrons are transferred from β-D-glucose to the enzyme yielding d-gluconolactone. In the oxidative half of the reaction, the enzyme is oxidized by molecular oxygen yielding hydrogen peroxide. The d-gluconolactone then reacts with water to hydrolyze the lactone ring and produce gluconic acid. In typical electrochemical sensors of the invention, the hydrogen peroxide produced by this reaction is oxidized at the working electrode (H₂O₂→2H++O₂+2e³¹ ).

### DETAILED DESCRIPTION OF THE PREFERRED EMBODIMENTS

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art. As appropriate, procedures involving the use of commercially available kits and reagents are generally carried out in accordance with manufacturer defined protocols and/or parameters unless otherwise noted.

Embodiments of the invention disclosed herein provide methods for producing electrochemical sensors of the type used, for example, in subcutaneous or transcutaneous monitoring of blood glucose levels in a diabetic patient. More specifically, the disclosure provided herein teaches methods for applying very thin enzyme coatings to specific elements within these sensors. The disclosure further provides sensors produced by such processes. Methods for producing the sensors of the invention include spin coating processes, dip and dry processes, low-shear spraying processes, ink-jet printing processes, silk screen processes and the like. Surprisingly, sensors having thin enzyme coatings produced by such processes have a number of improved qualities including enhanced longevity, linearity, regularity as well as improved signal to noise ratios.

While preferred embodiments of the invention pertain to glucose sensors, such thin enzyme coating can be adapted for use with any one of the wide variety of sensors known in the art. A number of enzyme sensors (e.g., glucose sensors which the enzyme glucose oxidase to effect a reaction of glucose and oxygen) are known in the art, and are within the skill in the art to fabricate. See, for example, U.S. Pat. Nos. 5,165,407, 4,890,620, 5,390,671 and 5,391,250, the disclosures of each being incorporated herein by reference. Sensors for monitoring glucose concentration of diabetics are further described in Shichiri, et al.,: “In Vivo Characteristics of Needle-type Glucose Sensor-Measurements of Subcutaneous Glucose Concentrations in Human Volunteers,” Horm. Metab. Res., Suppl. Ser. 20:17-20 (1988); Bruckel, et al.,: “In Vivo Measurement of Subcutaneous Glucose Concentrations with an Enzymatic Glucose Sensor and a Wick Method,” Klin. Wochenschr. 67:491-495 (1989); and Pickup, et al.,: “In Vivo Molecular Sensing in Diabetes Mellitus: An Implantable Glucose Sensor with Direct Electron Transfer,” Diabetologia 32:213-217 (1989). Other sensors are described in, for example Reach, et al., in ADVANCES IN IMPLANTABLE DEVICES, A. Turner (ed.), JAI Press, London, Chap. 1, (1993), incorporated herein by reference. Specific aspects of the invention are discussed in detail in the following sections.

A. Extremely Thin Enzymatic Coatings of the Invention

A significant aspect of the present invention involves processes for making sensors having improved electrode chemistry coatings (e.g., enzyme coatings of less than 2 microns in thickness) with enhanced material properties. Methods for producing the extremely thin enzyme coatings of the invention include spin coating processes, dip and dry processes, low shear spraying processes, ink-jet printing processes, silk screen processes and the like. Typically, such coatings are vapor crosslinked subsequent to their application. Surprisingly, sensors produced by these processes have material properties that exceed those of sensors having coatings produced by electrodeposition including enhanced longevity, linearity, regularity as well as improved signal to noise ratios. In addition, certain sensor embodiments of the invention that utilize glucose oxidase coatings formed by such processes are designed to recycle hydrogen peroxide and improve the biocompatibility profiles of such sensors.

While not being bound by a specific scientific theory, it is believed that sensors produced by such processes have surprisingly enhanced characteristics as compared to those generated by electrodeposition because electrodeposition produces 3-5 micron thick enzyme layers in which only a fraction of the reactive enzyme within the coating layer is able to access the analyte to be sensed. In sensors utilizing glucose oxidase, the thick coatings produced by electrodeposition may hinder the ability of hydrogen peroxide generated at the reactive interface of the 3-5 micron thick enzyme layer to contact the sensor surface and thereby generate a signal. In addition, hydrogen peroxide that is unable to reach a sensor surface due to such thick coatings can diffuse away from the sensor into the environment in which the sensor is placed, thereby decreasing the biocompatibility of such sensors.

In addition, while not being bound by a specific scientific theory, it is believed that the unexpected properties of sensors produced by such processes further results from the fact that processes such as spin coating, or the like, allow for a precise control over the enzyme coating's ratio of glucose oxidase to albumin (which is used as a carrier protein to stabilize the glucose oxidase in the enzyme layer). Specifically, because glucose oxidase and albumin have different isoelectric points, electrodeposition processes may result in a surface coating in which an optimally determined ratio of enzyme to carrier protein is detrimentally altered in the electrodeposition process and further wherein the glucose oxidase and the carrier protein are not distributed in a substantially uniform manner throughout the disposed enzyme layer.

In this context, a preferred embodiment of the invention is a method of making a less than about 2 micron coating of stabilized glucose oxidase on the surface of a matrix such as an electrode comprising combining glucose oxidase with albumin in a fixed ratio (one that is typically optimized for glucose oxidase stabilizing properties) and applying the glucose oxidase and albumin mixture to the surface of the matrix by a process selected from the group consisting of a spin coating process, a dip and dry process, a microdeposition process, a jet printer deposition process, a screen printing process or a doctor blading process. Preferably the stabilized glucose oxidase coating is applied to the surface of an electrode by a spin coating process. In highly preferred embodiments, the glucose oxidase/albumin is prepared in a physiological solution (e.g., phosphate buffered saline at neutral pH) with the albumin being present in an amount of about 5% albumin by weight. Optionally the stabilized glucose oxidase layer that is formed on the sensor layer is less than 2, 1, 0.5, 0.25 or 0.1 microns in thickness. A closely related embodiment of the invention is a stabilized glucose oxidase layer for coating the surface of an electrode wherein the glucose oxidase is mixed with a carrier protein in a fixed ratio within the layer, the glucose oxidase and the carrier protein are distributed in a substantially uniform manner throughout the layer. Preferably the layer is less than 2 microns in thickness.

B. Analyte Sensors of the Invention

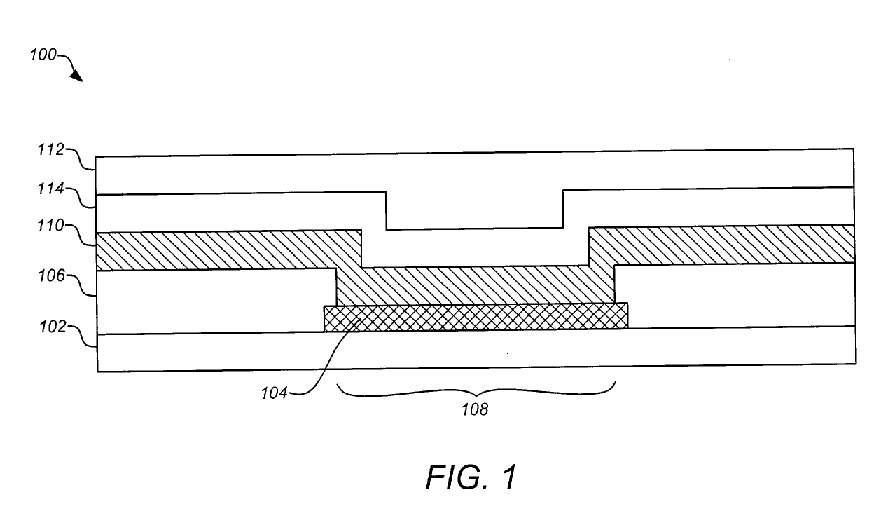

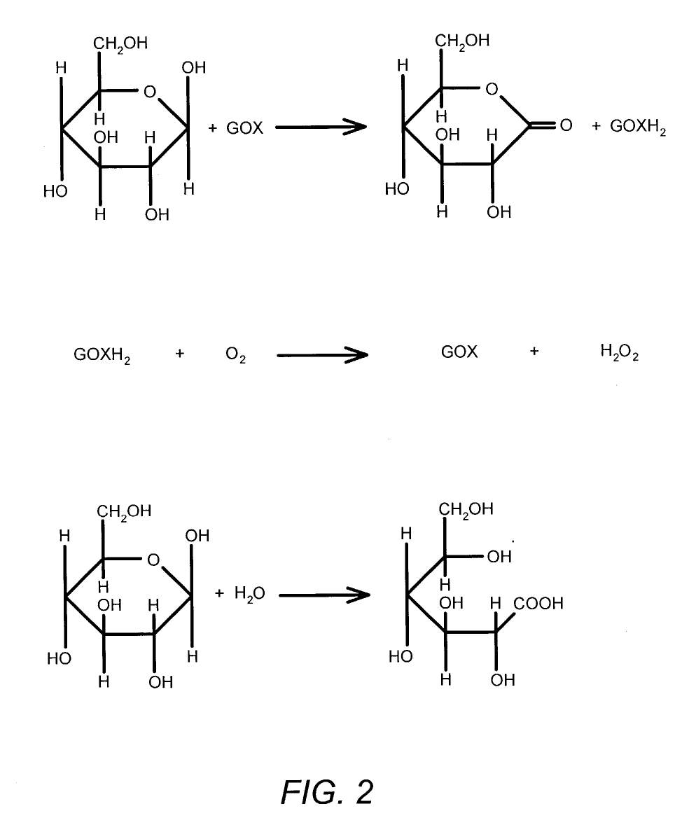

The invention disclosed herein includes a number of embodiments including sensors having very thin enzyme coatings. Illustrative general embodiments of the sensor disclosed herein include a base layer, a cover layer and at least one sensor layer having a sensor element such as an electrode disposed between the base and cover layers. Typically, an exposed portion of one or more sensor elements (e.g., a working electrode, a counter electrode, reference electrode, etc.) is coated with a very thin layer of material having an appropriate electrode chemistry. For example, an enzyme such as glucose oxidase, glucose dehydrogenase or hexokinase, can be disposed on the exposed portion of the sensor element within an opening or aperture defined in the cover layer. FIG. 1 illustrates a cross-section of a typical sensor structure 100 of the present invention. The sensor is formed from a plurality of layers of various conductive and non-conductive constituents disposed on each other according to a method of the invention to produce a sensor structure 100.

A preferred embodiment of the invention is shown in FIG. 1. This embodiment includes an electrically insulating base layer 102 to support the sensor 100. The electrically insulating layer base 102 can be made of a material such as a polyimide substrate, which may be self-supporting or further supported by another material as is known in the art. In one embodiment, the electrically insulating layer 102 comprises a polyimide tape, dispensed from a reel. Providing the layer 102 in this form can facilitate clean, high density mass production. Further, in some production processes using such a polyimide tape, sensors 100 can be produced on both sides of the tape.

Typical embodiments of the invention include a sensor layer disposed on the base layer 102. In a preferred embodiment as shown in FIG. 1 the sensor layer comprises a conductive layer 104 which is disposed on insulating base layer 102. Preferably the conductive layer 104 comprises one or more electrodes. The conductive layer 104 can be applied using many known techniques and materials as will be described hereafter, however, the electrical circuit of the sensor 100 is typically defined by etching the disposed conductive layer 104 into a desired pattern of conductive paths. A typical electrical circuit for the sensor 100 comprises two or more adjacent conductive paths with regions at a proximal end to form contact pads and regions at a distal end to form sensor electrodes. An electrically insulating protective layer 106 such as a polymer coating is typically disposed on portions of the conductive layer 104. Acceptable polymer coatings for use as the insulating protective layer 106 can include, but are not limited to, non-toxic biocompatible polymers such as polyimide, biocompatible solder masks, epoxy acrylate copolymers, or the like. Further, these coatings can be photo-imageable to facilitate photolithographic forming of apertures 108 through to the conductive layer 104.

In the sensors of the present invention, one or more exposed regions or apertures 108 can be made through the protective layer 106 to the conductive layer 104 to define the contact pads and electrodes of the sensor 100. In addition to photolithographic development, the apertures 108 can be formed by a number of techniques, including laser ablation, chemical milling or etching or the like. A secondary photoresist can also be applied to the protective layer 106 to define the regions of the protective layer to be removed to form the apertures 108. An operating sensor 100 typically includes a plurality of electrodes such as a working electrode and a counter electrode electrically isolated from each other, however typically situated in close proximity to one another. Other embodiments may also include a reference electrode. Still other embodiments may utilize an separate reference not formed on the sensor. The exposed electrodes and/or contact pads can also undergo secondary processing through the apertures 108, such as additional plating processing, to prepare the surfaces and/or strengthen the conductive regions.

A thin sensor chemistry layer 110 is typically disposed on one or more of the exposed electrodes of the conductive layer 104 through the apertures 108. Preferably, the sensor chemistry layer 110 is an enzyme layer. Most preferably, the sensor chemistry layer 110 comprises the enzyme glucose oxidase. In such embodiments, the sensor chemistry layer 110 reacts with glucose to produce hydrogen peroxide which modulates a current to the electrode which can be monitored to measure an amount of glucose present. The sensor chemistry layer 110 can be applied over portions of the sensor layer or over the entire region of the sensor layer, including the protective layer 106 as shown in FIG. 1. Preferably the sensor chemistry layer 110 is disposed on portions of a working electrode and a counter electrode that comprise the sensor layer. Preferred methods for generating the thin sensor chemistry layer 110 include spin coating processes, dip and dry processes, low shear spraying processes, ink-jet printing processes, silk screen processes and the like. Most preferably the thin sensor chemistry layer 110 is applied using a spin coating process.

Typically, the thin sensor chemistry layer 110 is coated with one or more cover layers. In preferred embodiments of the invention, the cover layer comprises a membrane which can regulate the amount of analyte that can contact the enzyme of the sensor layer. For example, the cover layer can comprise a glucose limiting membrane, which regulates the amount of glucose that contacts the glucose oxidase enzyme layer on an electrode. Such glucose limiting membranes can be made from a wide variety of materials known to be suitable for such purposes, e.g., silicone, polyurethane, polyurea cellulose acetate, Nafion, polyester sulfonic acid (Kodak AQ), hydrogels or any other membrane known to those skilled in the art.

In preferred embodiments of the invention, the cover layer is a glucose limiting membrane layer 112 which is disposed above the sensor chemistry layer 110 to regulate glucose contact with the sensor chemistry layer 110. In some embodiments of the invention, an adhesion promoter layer 114 is disposed between the membrane layer 112 and the sensor chemistry layer 110 as shown in FIG. 1 in order to facilitate their contact and/or adhesion. The adhesion promoter layer 114 can be made from any one of a wide variety of materials known in the art to facilitate the bonding between such layers. Preferably, the adhesion promoter layer 114 comprises a silane compound. In alternative embodiments, protein or like molecules in the sensor chemistry layer 110 can be sufficiently crosslinked or otherwise prepared to allow the membrane layer 112 to be disposed in direct contact with the sensor chemistry layer 110 in the absence of an adhesion promoter layer 114.

The sensors of the invention can have any desired configuration, for example planar or cylindrical. The base layer 102 can be self-supportive, such as a rigid polymeric layer, or non-self supportive, such as a flexible film. The latter embodiment is desirable in that it permits continuous manufacture of sensors using, for example, a roll of a polymeric film which is continuously unwound and upon which sensor elements, cover layers and functional coating layers are continuously applied.

As noted above, embodiments of the invention typically include a sensor layer having one or more sensor elements. According to the present invention, useful sensor elements (referred to herein as conductive elements) include thin film conductors or other electrically conductive elements that produce detectable electrical signals. Preferably, such conductive elements are electrodes. Preferably, an enzyme, such as glucose oxidase, is disposed in the aperture 108 defined above the sensor element.

According to a specific preferred embodiment, the sensor element is an electrically conductive sensor element. However, sensor elements of the present invention are not limited to conductive elements. Other useful sensor elements can be formed from any material that is capable of producing a detectable signal after interacting with a preselected analyte whose presence is to be detected (referred to herein as reactive elements). The detectable signal can be, for example, an optically detectable change, such as a color change or a visible accumulation of the desired analyte (e.g., cells). Exemplary materials include polymers that bind specific types of cells; single-strand DNA; antigens; antibodies and reactive fragments thereof; etc. Sensor elements can also be formed from materials that are essentially non-reactive (i.e., controls). The foregoing alternative sensor elements are beneficially included, for example, in sensors for use in cell-sorting assays and assays for the presence of pathogenic organisms, such as viruses (HIV, hepatitis-C, etc.), bacteria, protozoa and the like.

Embodiments of the present invention can include one or more functional coating layers. As used herein, the term “functional coating layer” denotes a layer that coats at least a portion of at least one surface of a sensor, more preferably substantially all of a surface of the sensor, and that is capable of interacting with one or more analytes, such as chemical compounds, cells and fragments thereof, etc., in the environment in which the sensor is disposed. Non-limiting examples of functional coating layers include sensor chemistry layers (e.g., enzyme layers), analyte limiting layers, biocompatible layers; layers that increase the slipperiness of the sensor; layers that promote cellular attachment to the sensor; layers that reduce cellular attachment to the sensor; and the like. Typically analyte limiting layers operate to prevent or restrict the diffusion of one or more analytes, such as glucose, through the layers. Optionally such layers can be formed to prevent or restrict the diffusion of one type of molecule through the layer (e.g. glucose), while at the same time allowing or even facilitating the diffusion of other types of molecules through the layer (e.g. O₂). An illustrative functional coating layer is a hydrogel such as those disclosed in U.S. Pat. Nos. 5,786,439 and 5,391,250, the disclosures of each being incorporated herein by reference. The hydrogels described therein are particularly useful with a variety of implantable devices for which it is advantageous to provide a surrounding water layer.

The sensor embodiments disclosed herein can include layers having UV-absorbing polymers. In accordance with one aspect of the present invention, there is provided a sensor including at least one functional coating layer including a UV-absorbing polymer. In preferred embodiments, the UV-absorbing polymer is a polyurethane, a polyurea or a polyurethane/polyurea copolymer. More preferably, the selected UV-absorbing polymer is formed from a reaction mixture including a diisocyanate, at least one diol, diamine or mixture thereof, and a polyfunctional UV-absorbing monomer.

UV-absorbing polymers are used with advantage in a variety of sensor fabrication methods, such as those described in U.S. Pat. No. 5,390,671, to Lord et al., entitled “Transcutaneous Sensor Insertion Set”; U.S. Pat. No. 5,165,407, to Wilson et al., entitled “Implantable Glucose Sensor”; and U.S. Pat. No. 4,890,620, to Gough, entitled “Two-Dimensional Diffusion Glucose Substrate Sensing Electrode”, which are incorporated herein in their entireties by reference. However, any sensor production method which includes the step of forming a UV-absorbing polymer layer above or below a sensor element is considered to be within the scope of the present invention. In particular, the inventive methods are not limited to thin-film fabrication methods, and can work with other sensor fabrication methods that utilize UV-laser cutting. Embodiments can work with thick-film, planar or cylindrical sensors and the like, and other sensor shapes requiring laser cutting.

As disclosed herein, the sensors of the present invention are particularly designed for use as subcutaneous or transcutaneous glucose sensors for monitoring blood glucose levels in a diabetic patient. Typically each sensor comprises a plurality of sensor elements, for example electrically conductive elements such as elongated thin film conductors, formed between an underlying insulative thin film base layer and an overlying insulative thin film cover layer.

If desired, a plurality of different sensor elements can be included in a single sensor. For example, both conductive and reactive sensor elements can be combined in one sensor, optionally with each sensor element being disposed on a different portion of the base layer. One or more control elements can also be provided. In such embodiments, the sensor can have defined in its cover layer a plurality of openings or apertures. One or more openings can also be defined in the cover layer directly over a portion of the base layer, in order to provide for interaction of the base layer with one or more analytes in the environment in which the sensor is disposed. The base and cover layers can be comprised of a variety of materials, typically polymers. In more specific embodiments the base and cover layers are comprised of an insulative material such as a polyimide. Openings are typically formed in the cover layer to expose distal end electrodes and proximal end contact pads. In a glucose monitoring application, for example, the sensor is placed transcutaneously so that the distal end electrodes are in contact with patient blood or extracellular fluid, and the contact pads are disposed externally for convenient connection to a monitoring device.

An illustrative embodiment of the invention is a sensor designed for implantation within a body that comprises a base layer, a sensor layer disposed upon the base layer which includes a plurality of sensor elements, an enzyme layer (preferably less than 2 microns in thickness) disposed upon the sensor layer which coats all of the plurality of sensing elements on the sensor layer, and a cover layer. Typically the enzyme layer comprises glucose oxidase, preferably in a substantially fixed ratio with a carrier protein. In a specific embodiment, the glucose oxidase and the carrier protein are distributed in a substantially uniform manner throughout the disposed enzyme layer. Typically the carrier protein comprises albumin, preferably in an amount of about 5% by weight. As used herein, “albumin” refers to those albumin proteins typically used by artisans to stabilize polypeptide compositions such as human serum albumin, bovine serum albumin and the like. In highly preferred embodiments of the invention, the cover layer is an analyte contacting layer which is disposed on the sensor so as to regulate the amount of analyte that can contact the enzyme layer. In further highly preferred embodiments, the sensor includes an adhesion promoter layer disposed between the enzyme layer and the analyte contacting layer and the enzyme layer is less than 1, 0.5, 0.25 or 0.1 microns in thickness.

A related embodiment of the invention is an electrochemical analyte sensor which includes a base layer, a sensor layer disposed upon the base layer that includes at least one working electrode and at least one counter electrode, an enzyme layer disposed upon the sensor layer, wherein the enzyme layer is less than 2 microns in thickness; and an analyte contacting layer that regulates the amount of analyte that contacts the enzyme layer. In a specific embodiment of the invention, the working electrode and/or the coated surface of the working electrode is larger than counter electrode and/or the coated surface of the counter electrode. In preferred embodiments, the enzyme layer comprises glucose oxidase stabilized by coating it on the working electrode and the counter electrode in combination with a carrier protein in a fixed ratio. In a highly preferred embodiment, the enzyme layer substantially covers the sensor layer. Embodiments where the glucose oxidase enzyme layer is disposed in a uniform coating over the whole sensor layer are preferred because they may avoid problems associated with sensors having multiple different coatings on a single layer such as the selective delamination of different coatings having different material properties. Optionally, the sensor includes an adhesion promoting layer disposed between the enzyme layer and the analyte contacting layer.

A related embodiment of the invention is an electrochemical analyte sensor which includes a base layer, a sensor layer disposed upon the base layer that includes at least one working electrode, at least one reference electrode and at least one counter electrode, an enzyme layer disposed upon the sensor layer, and an analyte contacting cover layer that regulates the amount of analyte that contacts the enzyme layer. In preferred embodiments, the enzyme layer is less than 2 microns in thickness and is coated on at least a portion of the working electrode, the reference electrode and the counter electrode. In a highly preferred embodiment, the enzyme layer substantially covers the working electrode, the reference electrode and the counter electrode. Optionally, the enzyme layer comprises glucose oxidase in combination with a carrier protein (e.g. albumin) in a fixed ratio. Typically, the sensor includes an adhesion promoting layer disposed between the enzyme layer and the analyte contacting layer.

Yet another embodiment of the invention comprises a glucose sensor for implantation within a body which includes a base layer, a sensor layer disposed upon the base layer, a glucose oxidase layer disposed upon the sensor layer, wherein the glucose oxidase is stabilized by combining it with albumin in a defined ratio and further wherein the glucose oxidase and the albumin are distributed in a substantially uniform manner throughout the disposed layer, and a glucose limiting layer that regulates the amount of glucose that contacts the glucose oxidase layer. In preferred embodiments, the sensor layer includes a plurality of sensor elements including at least one working electrode and at least one counter electrode. In such sensor embodiments, the glucose oxidase layer is preferably less than 2, 1, 0.5, 0.25 or 0.1 microns in thickness and the albumin in the layer is present in an amount of about 5% albumin by weight. Preferably the sensor includes an adhesion promoting layer disposed between the glucose oxidase layer and the glucose limiting layer.

A highly preferred embodiment of the invention is an electrochemical glucose sensor having hydrogen peroxide recycling capabilities. Typically such sensors include a base layer, a sensor layer disposed upon the base layer, wherein the sensor layer includes at least one working electrode and at least one counter electrode, a glucose oxidase layer disposed upon the sensor layer, wherein the glucose oxidase layer coats at least a portion of the working electrode and at least a portion of the counter electrode in a manner such that the working electrode oxidizes hydrogen peroxide that is produced by glucose oxidase upon reaction with glucose, and a glucose limiting layer disposed on the sensor so as to regulate the amount of glucose that can contact the glucose oxidase layer and to inhibit the diffusion of hydrogen peroxide into the environment in which the sensor is placed. Typically such sensors include an adhesion promoting layer disposed between the glucose oxidase layer and the glucose limiting layer. In addition such sensors usually include an insulation layer between the base layer and the glucose oxidase layer. The embodiments of the invention relating to electrochemical glucose sensors having hydrogen peroxide recycling capabilities are particularly preferred because the recycling of this molecule reduces the amount of hydrogen peroxide that can escape from the sensor into the environment in which it is placed. In this context, implantable sensors that are designed to reduce the release of tissue irritants such as hydrogen peroxide will have improved biocompatibility profiles. Consequently, yet another embodiment of the invention is a method of improving the biocompatibility of a glucose oxidase sensor by designing the sensor to incorporate the hydrogen peroxide recycling elements disclosed herein.

In certain embodiments of the invention disclosed herein (e.g., those having hydrogen peroxide recycling capabilities) the sensor layer has a plurality of electrodes including a working electrode and a counter electrode, both of which are coated with a layer of glucose oxidase. Such sensor designs have surprising properties including an enhanced sensitivity. Without being bound by a specific theory, these properties may result from the enhanced oxidation of hydrogen peroxide at the surface of the electrode which produces additional oxygen that can be utilized in the glucose sensing reaction (see, e.g., FIG. 2). Therefore this recycling effect may reduce the oxygen dependent limitations of such sensors. Moreover, this design may result in a sensor having a counter electrode that can readily reduce available hydrogen peroxide and consequently has a lower electrode potential. Sensors designed to function with lower electrode potentials are preferred embodiments of the invention because high electrode potentials in sensors of this type can result in a gas producing hydrolysis reaction which can destabilize the sensors (due to the disruption of sensor layers from gas bubbles produced by hydrolysis reactions). In addition, in sensor embodiments designed so that the counter electrode is coated with a very thin layer of glucose oxidase, the hydrogen peroxide generated when glucose reacts with glucose oxidase is very close to the reactive surface of the counter electrode. This can increase the overall efficiency of the sensor in a manner that allows for the production of compact sensor designs which include for example, counter electrodes with smaller reactive surfaces.

A variety of art-accepted methods and materials can be utilized to generate such sensors. For example, while a variety adhesion promoting compounds are known in the art, typically this layer comprises a silane compound. In preferred embodiments of the invention, the base layer comprises a polyimide, the insulation layer comprises a polyimide, an electrode comprises platinum black and the glucose limiting layer comprises a hydrophilic polymer. Preferably, the glucose oxidase layer is vapor crosslinked on the sensor layer.

C. Methods for Producing Analyte Sensors of the Invention

The disclosure provided herein teaches methods for applying very thin enzyme coatings to these types of sensors as well as sensors produced by such processes. In this context, preferred embodiments of the invention include methods for making such sensors on a substrate according to art accepted processes. In certain embodiments, the substrate comprises a rigid and flat structure suitable for use in photolithographic mask and etch processes. In this regard, the substrate typically defines an upper surface having a high degree of uniform flatness. A polished glass plate may be used to define the smooth upper surface. Alternative substrate materials include, for example, stainless steel, aluminum, and plastic materials such as delrin, etc. In other embodiments, the substrate is non-rigid and can be another layer of film or insulation that is used as a substrate, for example plastics such as polyimides and the like.

An initial step in the methods of the invention typically includes the formation of a base layer of the sensor. The base layer can be disposed on the substrate by any desired means, for example by controlled spin coating. In addition, an adhesive may be used if there is not sufficient adhesion between the substrate layer and the base layer. A base layer of insulative material is formed on the substrate, typically by applying the base layer material onto the substrate in liquid form and thereafter spinning the substrate to yield the base layer of thin, substantially uniform thickness. These steps are repeated to build up the base layer of sufficient thickness, followed by a sequence of photolithographic and/or chemical mask and etch steps to form the conductors discussed below. In a preferred form, the base layer comprises a thin film sheet of insulative material, such as polyimide having a film thickness on the order of about 0.003 inch.

The methods of the invention further include the generation of a sensor layer having one or more sensor elements. Typically these sensor elements are electrodes that are formed by one of the variety of methods known in the art such as photoresist, etching and rinsing to define the geometry of the active electrodes. The electrodes can then be made electrochemically active, for example by electrodeposition of Pt black for the working and counter electrode, and silver followed by silver chloride on the reference electrode. The enzyme layer is then disposed on the sensor layer by a method other than electrochemical deposition, followed by vapor crosslinking, for example with a dialdehyde (glutaraldehyde) or a carbodi-imide.

In an exemplary embodiment of the invention, the base layer is initially coated with a thin film conductive layer by electrode deposition, surface sputtering, or other suitable process step. In the preferred form, this conductive layer may be provided as a plurality of thin film conductive layers, such as an initial chrome-based layer suitable for chemical adhesion to a polyimide base layer followed by subsequent formation of thin film gold-based and chrome-based layers in sequence. In alternative embodiments, other electrode layer conformations or materials can be used. The conductive layer is then covered, in accordance with conventional photolithographic techniques, with a selected photoresist coating, and a contact mask can be applied over the photoresist coating for suitable photoimaging. The contact mask typically includes one or more conductor trace patterns for appropriate exposure of the photoresist coating, followed by an etch step resulting in a plurality of conductive sensor traces remaining on the base layer. In an illustrative sensor construction designed for use as a subcutaneous glucose sensor, each sensor trace can include three parallel sensor elements corresponding with three separate electrodes such as a working electrode, a counter electrode and a reference electrode.

Portions of the conductive sensors are typically covered by a insulative layer, preferably of a material such as a polyimide. The insulative layer can be applied in any desired manner. In an exemplary procedure, the insulative layer is applied in a liquid layer over the sensor traces, after which the substrate is spun to distribute the liquid material as a thin film overlying the sensor traces and extending beyond the marginal edges of the sensor traces in sealed contact with the base layer. This liquid material can then be subjected to one or more suitable radiation and/or chemical and/or heat curing steps as are known in the art. In alternative embodiments, the liquid material can be applied using spray techniques or any other desired means of application. Various insulative layer materials may be used such as photoimagable epoxyacrylate, with a preferred material comprising a photoimagable polyimide available from OCG, Inc. of West Paterson, N.J., under the product number 7020.

Appropriate electrode chemistries defining the distal end electrodes can be applied to the sensor tips, optionally subsequent to exposure of the sensor tips through the openings. In an illustrative sensor embodiment having three electrodes for use as a glucose sensor, an enzyme (preferably glucose oxidase) is provided within one of the openings, thus coating one of the sensor tips to define a working electrode. One or both of the other electrodes can be provided with the same coating as the working electrode. Alternatively, the other two electrodes can be provided with other suitable chemistries, such as other enzymes, left uncoated, or provided with chemistries to define a reference electrode and a counter electrode for the electrochemical sensor.

A significant aspect of the present invention involves processes for making sensors having extremely thin coatings for electrode chemistries (e.g., enzyme coatings of less than 2 microns in thickness) with enhanced material properties. Methods for producing the extremely thin enzyme coatings of the invention include spin coating processes, dip and dry processes, low shear spraying processes, ink-jet printing processes, silk screen processes and the like. As artisans can readily determine the thickness of an enzyme coat applied by process of the art, they can readily identify those methods capable of generating the extremely thin coatings of the invention. Typically, such coatings are vapor crosslinked subsequent to their application. Surprisingly, sensors produced by these processes have material properties that exceed those of sensors having coatings produced by electrodeposition including enhanced longevity, linearity, regularity as well as improved signal to noise ratios. In addition, embodiments of the invention that utilize glucose oxidase coatings formed by such processes are designed to recycle hydrogen peroxide and improve the biocompatibility profiles of such sensors.

While not being bound by a specific scientific theory, it is believed that the surprising properties of sensors produced by such processes have enhanced characteristics as compared to those generated by electrodeposition because electrodeposition produces 3-5 micron thick enzyme layers in which only a fraction of the reactive enzyme is able to access the analyte to be sensed. Moreover, in sensors utilizing glucose oxidase, the thick coatings produced by electrodeposition may hinder the ability of hydrogen peroxide generated at the reactive interface to reach the sensor surface and thereby generate a signal. Moreover, hydrogen peroxide that is unable to reach a sensor surface due to such thick coatings typically diffuses away from the sensor into the environment in which the sensor is placed, thereby decreasing the biocompatibility of such sensors. In addition, as glucose oxidase and albumin have different isoelectric points, electrodeposition processes can result in a surface coating in which an optimally determined ratio of enzyme to carrier protein is detrimentally altered and further wherein the glucose oxidase and the carrier protein are not distributed in a substantially uniform manner throughout the disposed enzyme layer. The thin coating processes utilized to produce the sensors disclosed herein avoid these problems associated with electrodeposition.

Sensors generated by processes such as spin coating processes also avoid other problems associated with electrodeposition, such as those pertaining to the material stresses placed on the sensor during the electrodeposition process. In particular, the process of electrodeposition is observed to produce mechanical stresses on the sensor, for example mechanical stresses that result from tensile and/or compression forces. In certain contexts, such mechanical stresses may result in sensors having coatings with some tendency to crack or delaminate. This is not observed in coatings disposed on sensor via spin coating or other low-stress processes. Consequently, yet another embodiment of the invention is a method of avoiding the electrodeposition influenced cracking and or delamination of a coating on a sensor comprising applying the coating via a spin coating process.

Subsequent to treatment of the sensor elements, one or more additional functional coating or cover layers can then be applied by any one of a wide variety of methods known in the art, such as spraying, dipping, etc. In preferred embodiments of the invention, the sensor is made by methods which apply a cover layer that comprises a hydrophilic membrane coating which can regulate the amount of analyte that can contact the enzyme of the sensor layer. For example, the cover layer that is added to the glucose sensors of the invention can comprise a glucose limiting membrane, which regulates the amount of glucose that contacts glucose oxidase enzyme layer on an electrode. Such glucose limiting membranes can be made from a wide variety of materials known to be suitable for such purposes, e.g., silicone, polyurethane, cellulose acetate, Nafion, polyester sulfonic acid (Kodak AQ), hydrogels or any other membrane known to those skilled in the art. In certain embodiments of the invention pertaining to sensors having hydrogen peroxide recycling capabilities, the membrane layer is disposed on the glucose oxidase enzyme layer to inhibit the release of hydrogen peroxide into the environment in which the sensor is placed and to facilitate the contact between the hydrogen peroxide molecules and the electrode sensing elements.

In some embodiments of the methods of invention, an adhesion promoter layer is disposed between the cover layer and the sensor chemistry layer in order to facilitate their contact. The adhesion promoter layer can be made from any one of a wide variety of materials known in the art to facilitate the bonding between such layers and can be applied by any one of a wide variety of methods known in the art. Preferably, the adhesion promoter layer comprises a silane compound. Like certain other coating layers of the sensor, the adhesion promoter layer can then be subjected to one or more suitable radiation and/or chemical and/or heat curing steps as are known in the art. In alternative embodiments, the enzyme layer can be sufficiently crosslinked or otherwise prepared to allow the membrane cover layer to be disposed in direct contact with the sensor chemistry layer in the absence of an adhesion promoter layer.

A preferred embodiment of the invention is a method of making a sensor by providing a base layer, forming a sensor layer on the base layer, spin coating an enzyme layer on the sensor layer and then forming an analyte contacting layer on the sensor, wherein the analyte contacting layer regulates the amount of analyte that can contact the enzyme layer. In preferred methods, the enzyme layer is vapor crosslinked on the sensor layer. In a typical embodiment of the invention, the sensor layer is formed to include at least one working electrode and at least one counter electrode. In highly preferred embodiments, the enzyme layer is formed on at least a portion of the working electrode and at least a portion of the counter electrode. Typically, the enzyme layer that is formed on the sensor layer is less than 2, 1, 0.5, 0.25 or 0.1 microns in thickness. Preferably, the enzyme layer comprises glucose oxidase, glucose dehydrogenase, lactose oxidase, hexokinase or lactose dehydrogenase. In a specific method, the enzyme layer comprises glucose oxidase that is stabilized by coating it on the sensor layer in combination with a carrier protein in a fixed ratio. Typically the carrier protein is albumin. Preferably such methods include the step of forming an adhesion promoter layer disposed between the glucose oxidase layer and the analyte contacting layer. Optionally, the adhesion promoter layer is subjected to a curing process prior to the formation of the analyte contacting layer.

A related embodiment of the invention is a method of making a glucose sensor by providing a base layer, forming a sensor layer on the base layer that includes at least one working electrode and at least one counter electrode, forming a glucose oxidase layer on the sensor layer by a spin coating process (a layer which is preferably stabilized by combining the glucose oxidase with albumin in a fixed ratio), wherein the glucose oxidase layer coats at least a portion of the working electrode and at least a portion of the counter electrode, and then forming an glucose limiting layer on the glucose sensor so as to regulate the amount of glucose that can contact the glucose oxidase layer. In such processes, the glucose oxidase layer that is formed on the sensor layer is preferably less than 2, 1, 0.5, 0.25 or 0.1 microns in thickness. Typically, the glucose oxidase coating is vapor crosslinked on the sensor layer. Optionally, the glucose oxidase coating covers the entire sensor layer. In highly preferred embodiments of the invention, an adhesion promoter layer disposed between the glucose oxidase layer and the analyte contacting layer

The finished sensors produced by such processes are typically quickly and easily removed from a supporting substrate (if one is used), for example, by cutting along a line surrounding each sensor on the substrate. The cutting step can use methods typically used in this art such as those that include a UV laser cutting device that is used to cut through the base and cover layers and the functional coating layers along a line surrounding or circumscribing each sensor, typically in at least slight outward spaced relation from the conductive elements so that the sufficient interconnected base and cover layer material remains to seal the side edges of the finished sensor. Since the base layer is typically not physically attached or only minimally adhered directly to the underlying supporting substrate, the sensors can be lifted quickly and easily from the supporting substrate, without significant further processing steps or potential damage due to stresses incurred by physically pulling or peeling attached sensors from the supporting substrate. The supporting substrate can thereafter be cleaned and reused, or otherwise discarded. Alternatively, the functional coating layer(s) can be applied after the sensor including base layer, sensor elements and cover layer is removed from the supporting substrate by cutting.

D. Kits and Sensor Sets of the Invention

In another embodiment of the invention, a kit and/or sensor set, useful for the sensing an analyte as is described above, is provided. The kit and/or sensor set typically comprises a container, a label and a sensor having an extremely thin enzyme coating as described above. Suitable containers include, for example, an easy to open package made from a material such as a metal foil, bottles, vials, syringes, and test tubes. The containers may be formed from a variety of materials such as metals (e.g. foils) paper products, glass or plastic. The container preferably holds a glucose sensor coated with a layer of glucose oxidase that is less than 2 microns in thickness. The label on, or associated with, the container indicates that the sensor is used for assaying the analyte of choice. The kit and/or sensor set may further include other materials desirable from a commercial and user standpoint, including elements or devices designed to facilitate the introduction of the sensor into the analyte environment, other buffers, diluents, filters, needles, syringes, and package inserts with instructions for use.

Various citations are referenced throughout the specification. In addition, certain text from related art is reproduced herein to more clearly delineate the various embodiments of the invention. The disclosures of all citations in the specification are expressly incorporated herein by reference.

1. A sensor for implantation within a body, the sensor comprising:
a base layer;
a sensor layer disposed upon the base layer wherein the sensor layer includes a plurality of sensor elements;
an enzyme layer disposed upon the sensor layer, wherein the enzyme layer is less than 2 microns in thickness and further wherein the enzyme layer coats all of the plurality of sensing elements on the sensor layer; and
a cover layer.

2. The sensor of claim 1, wherein the enzyme layer comprises glucose oxidase.

3. The sensor of claim 2, wherein the enzyme layer further comprises a carrier protein in a substantially fixed ratio with the glucose oxidase.

4. The sensor of claim 3, wherein the glucose oxidase and the carrier protein are distributed in a substantially uniform manner throughout the disposed enzyme layer.

5. The sensor of claim 3, wherein the carrier protein comprises albumin.

6. The sensor of claim 5, wherein the albumin is present in an amount of about 5% albumin by weight.

7. The sensor of claim 1, wherein the cover layer is a analyte contacting layer; wherein the analyte contacting layer is disposed on the sensor so as to regulate the amount of analyte that can contact the enzyme layer.

8. The sensor of claim 1, wherein the enzyme layer is a thickness selected from the group consisting of less than 1, 0.5, 0.25 and 0.1 microns.

9. The sensor of claim 7, further comprising an adhesion promoter layer disposed between the enzyme layer and the analyte contacting layer.

10. An electrochemical analyte sensor, the sensor comprising:
a base layer;
a sensor layer disposed upon the base layer wherein the sensor layer includes at least one working electrode, at least one counter electrode, and at least one reference electrode;
an enzyme layer disposed upon the sensor layer, wherein the enzyme layer is less than 2 microns in thickness; and
an analyte contacting layer; wherein the analyte contacting layer regulates the amount of analyte that contacts the enzyme layer.

11. The sensor of claim 10, wherein the coated surface of the working electrode is larger than the coated surface of the counter electrode.

12. The sensor of claim 11, wherein the enzyme layer comprises glucose oxidase and further wherein the glucose oxidase is stabilized by coating it on the working electrode, the counter electrode and the reference electrode in combination with a carrier protein in a fixed ratio.

13. The sensor of claim 10, wherein the enzyme layer substantially covers the sensor layer.

14. The sensor of claim 10, further comprising an adhesion promoter layer disposed between the enzyme layer and the analyte contacting layer.

15. A glucose sensor for implantation within a body, the sensor comprising:
a base layer;
a sensor layer disposed upon the base layer,
a glucose oxidase layer disposed upon the sensor layer, wherein the glucose oxidase is stabilized by combining it with albumin in a defined ratio and further wherein the glucose oxidase and the albumin are distributed in a substantially uniform manner throughout the disposed layer; and
a glucose limiting layer; wherein the glucose limiting layer regulates the amount of glucose that contacts the glucose oxidase layer.

16. The sensor of claim 15, wherein the sensor layer includes a plurality of sensor elements including at least one working electrode and at least one counter electrode.

17. The sensor of claim 15, wherein the glucose oxidase layer is a thickness selected from the group consisting of less than 1, 0.5, 0.25 and 0.1 microns.

18. The sensor of claim 15, wherein the albumin is present in an amount of about 5% albumin by weight.

19. The sensor of claim 15, further comprising an adhesion promoter layer disposed between the glucose oxidase layer and the glucose limiting layer.

20. An electrochemical glucose sensor having hydrogen peroxide recycling capabilities, the sensor comprising:
a base layer;
a sensor layer disposed upon the base layer wherein the sensor layer includes at least one working electrode and at least one counter electrode;
a glucose oxidase layer disposed upon the sensor layer, wherein the glucose oxidase layer coats at least a portion of the working electrode and at least a portion of the counter electrode in a manner such that the working electrode oxidizes hydrogen peroxide that is produced by glucose oxidase upon reaction with glucose; and
a glucose limiting layer; wherein the glucose limiting layer is disposed on the sensor so as to regulate the amount of glucose that can contact the glucose oxidase layer and further wherein the glucose limiting layer is disposed on the sensor so as to inhibit the diffusion of hydrogen peroxide into the environment in which the sensor is placed.

21. The sensor of claim 20, further comprising an adhesion promoter layer disposed between the glucose oxidase layer and the glucose limiting layer.

22. The sensor of claim 21, wherein the adhesion promoter layer comprises a silane compound.

23. The sensor of claim 20, wherein the sensor further includes an insulation layer between the base layer and the glucose oxidase layer.

24. The sensor of claim 20, wherein the insulation layer comprises a polyimide.

25. The sensor of claim 20, wherein an electrode comprises platinum black.

26. The sensor of claim 20, wherein the glucose oxidase layer is vapor crosslinked on the sensor layer.

27. The sensor of claim 20, wherein the glucose oxidase layer is stabilized by coating it on the sensor layer in combination with a carrier protein in a fixed ratio.

28. The sensor of claim 20, wherein the base layer comprises a polyimide.

29. The sensor of claim 20, wherein the glucose limiting layer comprises a hydrophilic polymer.

30. A method of making a sensor comprising the steps of:
a providing a base layer;
forming a sensor layer on the base layer;
spin coating an enzyme layer on the sensor layer; and
forming an analyte contacting layer on the sensor, wherein the analyte contacting layer regulates the amount of analyte that can contact the enzyme layer.

31. The method of claim 30, further comprising vapor crosslinking the enzyme layer.

32. The method of claim 30, further wherein the sensor layer includes at least one working electrode and at least one counter electrode.

33. The method of claim 32, wherein the enzyme layer is formed on at least a portion of the working electrode and at least a portion of the counter electrode.

34. The sensor of claim 30, wherein the enzyme layer that is formed on the sensor layer is a thickness selected from the group consisting of less than 1, 0.5, 0.25 and 0.1 microns.

35. The method of claim 30, wherein the enzyme layer comprises glucose oxidase, glucose dehydrogenase, lactose oxidase, hexokinase or lactose dehydrogenase.

36. The method of claim 35, wherein the enzyme layer comprises glucose oxidase and further wherein the glucose oxidase is stabilized by coating it on the sensor layer in combination with a carrier protein in a fixed ratio.

37. The method of claim 36, wherein the wherein the carrier protein is albumin and further wherein the glucose oxidase and the albumin are distributed in a substantially uniform manner throughout the disposed enzyme layer.

38. The method of claim 30, further comprising forming an adhesion promoter layer disposed between the glucose oxidase layer and the analyte contacting layer.

39. The method of claim 38, wherein the adhesion promoter layer is subjected to a curing process prior to the formation of the analyte contacting layer.

40. A method of making a glucose sensor comprising the steps of:
a providing a base layer;
forming a sensor layer on the base, wherein the sensor layer includes at least one working electrode and at least one counter electrode;
forming a glucose oxidase layer on the sensor layer by a spin coating process, wherein the glucose oxidase layer coats at least a portion of the working electrode and at least a portion of the counter electrode; and
forming an glucose limiting layer on the glucose sensor so as to regulate the amount of glucose that can contact the glucose oxidase layer.

41. The method of claim 40, wherein the wherein the glucose oxidase layer that is formed on the sensor layer is a thickness selected from the group consisting of less than 1, 0.5, 0.25 and 0.1 microns.

42. The method of claim 40, further comprising vapor crosslinking the glucose oxidase layer.

43. The method of claim 40, wherein the glucose oxidase layer is stabilized by combining the glucose oxidase with albumin in a fixed ratio.

44. The method of claim 40, further comprising forming an adhesion promoter layer disposed between the glucose oxidase layer and the analyte contacting layer.

45. A method of making a less than about 2 micron coating of stabilized glucose oxidase on the surface of at least one electrode comprising combining glucose oxidase with albumin in a ratio of about 20,000 units of glucose oxidase and about 5% albumin by weight and applying the glucose oxidase and albumin mixture to the surface of an electrode by a process selected from the group consisting of a spin coating process, a dip and dry process, a microdeposition process, a jet printer deposition process, a screen printing process or a doctor blading process.

46. The methods of claim 45, wherein the stabilized glucose oxidase coating is applied to the surface of the electrode by a spin coating process.

47. The method of claim 45, wherein the stabilized glucose oxidase coating is formed on the on the surface of at least two electrodes.

48. The method of claim 45, wherein the albumin is present in an amount of about 5% albumin by weight.

49. The method of claim 45, wherein the wherein the stabilized glucose oxidase layer that is formed on the sensor layer is a thickness selected from the group consisting of less than 1, 0.5, 0.25 and 0.1 microns.

50. A stabilized glucose oxidase layer for coating the surface of an electrode wherein:
the glucose oxidase is mixed with a carrier protein in a fixed ratio within the layer;
the glucose oxidase and the carrier protein are distributed in a substantially uniform manner throughout the layer; and
the layer is less than 2 microns in thickness.
